(19) United States
(12) Patent Application Publication
(10) Pub. No.: US 2007/0040508 A1
(43) Pub. Date: Feb. 22, 2007

(54) Flat fluorescent lamp

(75) Inventors: Yu-Heng Hsieh, Hsinchu Hsien (TW); Chien-Hsing Lee, Taoyuan Hsien (TW); Jau-Shiu Chen, Hsinchu Hsien (TW); Lai-Cheng Chen, Hsinchu Hsien (TW)

Correspondence Address: BIRCH STEWART KOLASCH & BIRCH, PO BOX 747, FALLS CHURCH, VA, 22040-0747, US

(73) Assignees: Delta Optoelectronics, Inc., Hsinchu Hsien (TW); DELTA ELECTRONICS, INC., Taoyuan Hsien (TW)

(21) Appl. No.: 11/585,876

(22) Filed: Oct. 25, 2006

Related U.S. Application Data
(63) Continuation-in-part of application No. 10/604,588, filed on Jul. 31, 2003, now Pat. No. 7,148,626.

(30) Foreign Application Priority Data
Dec. 24, 2002 (TW) 091137109

(51) Int. Cl. H01J 65/00; H01J 61/06; H01J 11/00

(52) U.S. Cl. 313/607

(57) ABSTRACT

A flat fluorescent lamp is disclosed. The flat fluorescent lamp comprises a gas discharge chamber, a fluorescent substance, a discharge gas, and a plurality of first and second electrodes. The fluorescent substance is disposed on an inner surface of the gas discharge chamber and the discharge gas is filled in the gas discharge chamber. An electrode pair includes the first and the second electrodes. The first and the second electrodes are disposed on different planes so that the discharge area formed between the first and the second electrodes is larger than that formed between the two electrodes on a same plane to perform better efficiency of luminance.

### PRIORITY FROM U.S. PATENT APPLICATIONS

The present application is a continuation-in-part (C.I.P.) application of U.S. patent application Ser. No. 10/604,588, filed on Jul. 31, 2003, which is entitled “FLAT LAMP STRUCTURE” which is fully incorporated herein by reference.

### BACKGROUND OF INVENTION

1. Field of the Invention

The present invention relates to a flat lamp structure having electrodes positioned on the outer wall of a gas discharge chamber, and in particular, to a flat fluorescent lamp having electrodes disposed on different planes.

2. Description of the Related Art

As a consequence of industrial progress, developments in mobile phones, digital cameras, digital video cameras, notebook computers, and desk-top computers are now concerned with multifunctional and aesthetic design. However, the display screen used in mobile phones, digital cameras, digital video cameras, notebook computers, and desk-top computers is an essential interactive interface. The display screen provides the user with great convenience of operation. In recent years, it has become commonplace for most mobile phones, digital cameras, digital video cameras, notebook computers, and desk-top computers to employ a LCD panel as the display screen. However, the LCD panel per se is non-luminous, and a back light module must be provided at the bottom of the LCD panel to provide a light source for displaying.

The flat lamp provides excellent luminosity and uniformity and also provides a larger surface area light source. Therefore, it is widely applied as a back light source for LCD panels and for other fields of applications. The flat lamp is a plasma luminous component, essentially utilizing the electrons emitted from the cathode to collide with the inert gas between the cathode and anode within the gas discharge chamber, and the gas is ionized and excited to form plasma. After that the excited state atoms of the plasma return to the ground state by emission of UV rays, the UV rays further excite the fluorescence substance within the flat lamp, producing visible light.

FIG. 1 is a schematic view showing the structure of a conventional flat lamp.

Referring to FIG. 1, the conventional flat lamp structure comprises a gas discharge chamber 100, a fluorescence substance 102, a discharge gas 104, electrodes 106 and dielectric layers 108. The gas discharge chamber 100 comprises a plate 100a, a second plate 100b and strip 100c mounted between the plate 100a and the plate 100b, and is connected to the edge of the plate 100a and the edge of plate 100b to form a closed chamber.

Referring again to FIG. 1, the conventional electrode 106 is generally a silver electrode, and the electrode 106 is disposed on the plate 100a. The electrode is generally covered with the dielectric layer 108 so as to protect the electrode 106 from damaging by the collision of the ions. As shown in FIG. 1, the dielectric layer 108 covering electrode 106 is positioned at the inner wall of the gas discharge chamber 100. The gas discharge chamber 100 is charged with a gas 104. Generally, the gas 104 includes Xe, Ne and Ar, or other inert gas. Moreover, the fluorescence substance 102 is disposed on the inner wall of the gas discharge chamber 100, for example on the surface of the plate 100b, on the surface of the dielectric layer 108, and on the surface of the plate 100a not covered by the dielectric layer 108.

In the process of ignition of the flat lamp, the electrode 106 emits electrons to collide with the discharge gas 104 within the gas discharge chamber 100, and the discharge gas 104 is ionized and excited to form plasma. After that, the excited state atoms of the plasma return to the ground state by emitting UV rays, and the emitted UV rays further excite the fluorescence substance 102 within the inner wall of the gas discharge chamber 100 to produce visible light. However, on the above light luminous mechanism, the high energy ions released by the plasma generally collide through the dielectric layer, and may reach further to the electrode 106. Thus, the longevity of the flat lamp is greatly reduced.

Please note that the dielectric layer 108 covering the electrode 106 is generally fabricated by a multiple screen printing process the thickness of which is controlled between 200 μm to 250 μm. However, the fabrication process of the multiple screen printing is complicated, and the test sample capacity and yield are low. In addition, multiple screen printing can easily cause unevenness in the thickness of the film, causing each of the test samples or a single test sample with different optical characteristics of different region to differ with each other. Due to the fact that the optical characteristics of the test sample cannot be easily controlled, the designing cost for the driving circuit is increased.

### SUMMARY OF INVENTION

Accordingly, it is an object of the present invention to provide a flat lamp structure which effectively avoids collision through the dielectric layer, improving the longevity of the flat lamp.

Another object of the present invention is to provide a flat lamp structure which effectively avoids the unevenness occurring on the dielectric substrate film due to multiple screen printing, thereby improving the luminosity and the uniformity of the flat lamp.

In order to achieve the above objects, the present invention provides a flat lamp structure comprising a gas discharge chamber; a fluorescence substance disposed on the inner wall of the gas discharge chamber; a discharge gas disposed in the gas discharge chamber; and a plurality of electrodes disposed on the outer wall of the gas discharge chamber.

The gas discharge chamber, for example, comprises a dielectric substrate; a plate disposed on the upper portion of the dielectric substrate; and a plurality of strips disposed between the dielectric substrate and the plate, and the plate connected to the edge of the dielectric substrate.

In order to achieve the above objects, the present invention provides a flat lamp structure comprising a gas discharge chamber; a fluorescence substance disposed on the inner wall of the gas discharge chamber; a discharge gas disposed in the gas discharge chamber; a plurality of electrodes disposed on the outer wall of the gas discharge chamber; and a spacer disposed on the gas discharge chamber to enhance the strength of the gas discharge chamber.

The gas discharge chamber, for example, comprises a dielectric substrate; a plate disposed on the upper portion of the dielectric substrate; and a plurality of strips disposed between the dielectric substrate and the plate, and plate connected to the edge of the dielectric substrate.

In accordance with a preferred embodiment of the present invention, the thickness of the dielectric substrate is, for example, between 0.3 mm and 1.1 mm, and the distance between the dielectric substrate and the plate, for example, is between 0.5 mm and 2.0 mm.

In accordance with the preferred embodiment of the present invention, the gas charged into the gas discharge chamber, for example, is Xe, Ne or Ar, and the electrodes, for example, include silver electrode or copper electrode.

In accordance with the preferred embodiment of the present invention, the lower portion of the dielectric substrate, for example, is stuck to a carrier substrate for carrying the gas discharge chamber containing the electrode.

In addition, an adhesive, for example, is disposed between the dielectric substrate and the carrier substrate and connects the dielectric substrate and the carrier substrate.

In accordance with the preferred embodiment of the present invention, the adhesive, for example, includes glass adhesive, UV curing adhesive or thermal curing adhesive.

In accordance with the present invention, the electrode is fabricated on the outer wall of the gas discharge chamber, and by means of the dielectric substrate as dielectric material for protecting the electrode, the uniformity with respect to thickness is good and the ability to withstand the collision of ions is excellent. Thus, the present invention does not require a dielectric layer formed by multiple screen printing covering the electrode, resulting in uniformity of luminosity and significant improvement in longevity.

Furthermore, in order to improve the longevity and efficiency of luminance, the flat fluorescent lamp of the present invention comprises at least an electrode pair formed by one first electrode and one second electrode on different planes.

In accordance with a preferred embodiment of the present invention, the first electrode is disposed on the outer surface of the dielectric substrate and the second electrode covered with a dielectric layer is disposed on the inner surface of the dielectric substrate.

In accordance with a preferred embodiment of the present invention, the first electrode is disposed on the outer surface of the dielectric substrate without covering the dielectric layer and the second electrode covered with the dielectric layer is disposed on the inner surface of the dielectric substrate. The first and second electrodes are both strip type and are perpendicular each other. Also, the first electrode could be planar type.

In accordance with a preferred embodiment of the present invention, the flat fluorescent lamp further comprises a carrier substrate beneath the dielectric substrate for supporting the flat fluorescent lamp. The first electrode is disposed on the outer surface of the dielectric substrate or is disposed on one surface of the carrier substrate facing the dielectric substrate. The second electrode covered with the dielectric layer is disposed on the inner surface of the dielectric substrate. An adhesive is disposed between the dielectric substrate and the carrier substrate for connecting the two substrates.

In accordance with a preferred embodiment of the present invention, the flat fluorescent lamp further comprises a third electrode disposed on the outer surface of the upper plate, or covered with the dielectric layer on the inner surface of the upper plate.

In accordance with a preferred embodiment of the present invention, the flat fluorescent lamp further comprises a reflective layer disposed beneath the dielectric substrate so that the first electrode is disposed between the dielectric substrate and the reflective layer. Based on the concept of the present invention, the second electrode is disposed on the outer surface of the reflective layer.

Based on the concept of the present invention, the electrode pair, including the first and the second electrodes, is disposed on the different planes so that the discharge area between the two electrodes is larger than that between two electrodes on the same plane in general. Thus, the flat fluorescent lamp of the present invention provides significant improvement in luminosity.

### BRIEF DESCRIPTION OF DRAWINGS

FIG. 1 is a schematic view of a conventional flat lamp structure;

FIGS. 2 and 3 are schematic views of a first preferred embodiment flat lamp in accordance with the present invention;

FIGS. 4 and 5 are schematic views of a second preferred embodiment flat lamp in accordance with the present invention;

FIG. 6 is a cross-sectional view of a third preferred embodiment of the flat fluorescent lamp in accordance with the present invention;

FIG. 7A is a cross-sectional view of a fourth preferred embodiment of the flat fluorescent lamp in accordance with the present invention;

FIGS. 7B and 7C are schematic views of the modifications of the dielectric substrate of the fourth preferred embodiment of the flat fluorescent lamp in accordance with the present invention;

FIG. 8 is a cross-sectional view of a fifth preferred embodiment of the flat fluorescent lamp in accordance with the present invention;

FIG. 9 is a cross-sectional view of a sixth preferred embodiment of the flat fluorescent lamp in accordance with the present invention; and

FIG. 10 is a cross-sectional view of a seventh preferred embodiment of the flat fluorescent lamp in accordance with the present invention.

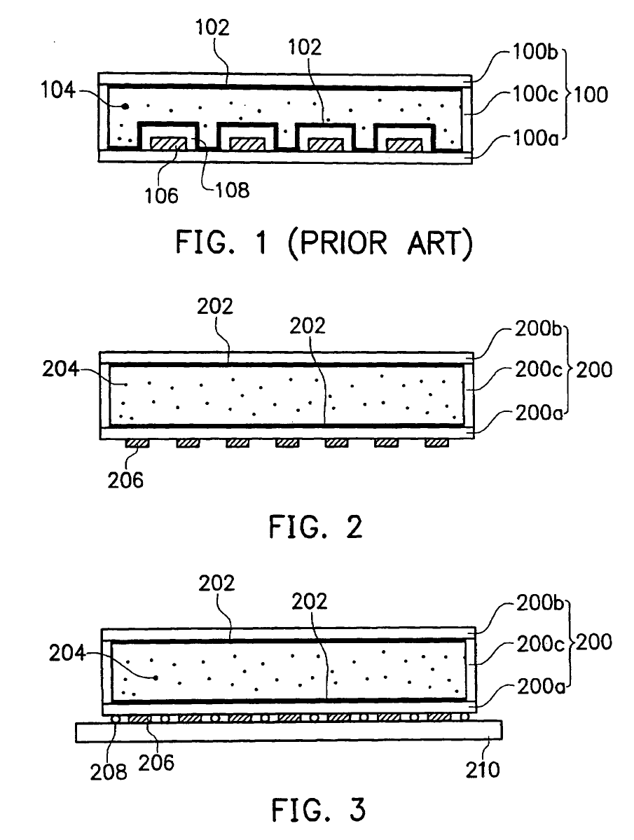

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

In the embodiments illustrated in the descriptions, the “inner surface” of the upper plate or the dielectric substrate indicated the surface facing the gas discharge chamber, and the “outer surface” of the upper plate or the dielectric substrate is the opposite side of the “inner surface”, respectively.

FIGS. 2 and 3 show schematically the flat lamp structure of a first preferred embodiment of the present invention.

First, referring to FIG. 2, the flat lamp comprises a gas discharge chamber 200, fluorescence substance 202, a discharge gas 204 and a plurality of electrodes 206. Wherein the material for forming the gas discharge chamber is, for example, glass. The gas discharge chamber 200, for instance, is a dielectric substrate 200a, a plate 200b and a plurality of strips 200c. The plate 200b is disposed on the upper portion of the dielectric substrate 200a, and the strips 200c are disposed between the dielectric substrate 200a and the plate 200b, and are connected to the dielectric substrate 200a and the edge of the plate 200b. In the present preferred embodiment, the thickness of the dielectric substrate is, for example, between 0.3 mm to 1.1 mm, and the distance between the dielectric substrate 200a and the plate 200b is, for example, between 0.5 mm and 2.0 mm.

Similarly, referring to FIG. 2, the fluorescence substance 202 is disposed on the inner wall of the gas discharged chamber 200, and the fluorescence substance 202 is generally disposed on the dielectric substrate 200a and the surface of the plate 200b. The gas 204 is charged into the gas discharge chamber 200, and examples of the gas are Xe, Ne, and Ar. The electrode 206 is disposed on the outer wall of the gas discharge chamber 200. Examples of the electrodes are silver electrode or copper electrode.

In the process of ignition of the flat lamp, the electrode 206 on the outer wall of the gas discharge chamber 200 is driven so that the electrode within the gas discharge chamber 202 partially emits electrons which collide with the gas 204, and the gas 204 is ionized and excited to form plasma. After that, the excited state atoms of the plasma return to the ground state by way of emission of UV rays, and the emitted UV rays further excite the fluorescence substance 202 on the inner wall of the gas discharge chamber 200 so as to produce visible light.

In accordance with the preferred embodiment during the driving process, the electrodes 206, isolated by the dielectric substrate 200a, form an electric field within the gas discharge chamber 200, and the thickness of the dielectric substrate 200a directly affects the difficulty of the driving process. When the thickness of the dielectric substrate 200a is large, the flat lamp is more difficult to drive, and vice versa; to facilitate the driving process, a thinner dielectric material 200a is used. In contrast, the dielectric substrate 200a may be broken for the reason that the substrate 200a cannot withstand the external atmospheric pressure. Thus, in order to consider both the difficulty of the driving process and the strength of the dielectric substrate 200a, the present preferred embodiment provides a flat lamp structure, as shown in FIG. 3.

Referring to FIG. 3, in order to obtain a balance between the difficulty of the driving process and the strength of the dielectric substrate 200a, the present flat lamp structure, as shown in FIG. 2, is supported on a carrier substrate 210, and the dielectric substrate 200a and the carrier substrate 210 are connected, for example, by means of an adhesive 208 having a thickness between 0.1 mm and 0.3 mm. In accordance with the present invention, the adhesive 208 includes, for example, glass adhesive, UV curing adhesive or thermal curing adhesive.

In accordance with the flat lamp structure, as the dielectric substrate 200a and the carrier substrate 210 are connected using the adhesive 208, the structural body constructed by the dielectric substrate 200a and the carrier substrate 210 can withstand the external atmospheric pressure, thus, as a whole, the strength of the flat lamp is enhanced.

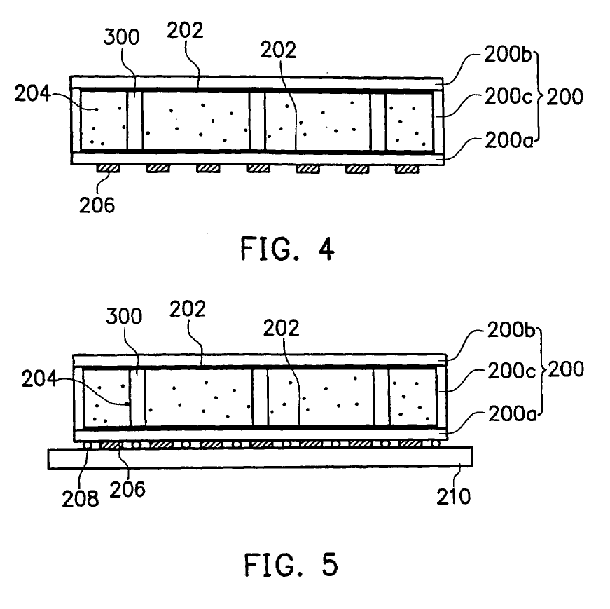

FIGS. 4 and 5 show a flat lamp structure in accordance with the second preferred embodiment. As shown in FIG. 4, the flat lamp comprises a gas discharge chamber 200, a fluorescence substance 202, a discharge gas 204, a plurality of electrodes 206 and at least a spacer 300, wherein the material of the gas discharge chamber 200 is, for example, glass. The gas discharge chamber 200 comprises a dielectric substrate 200a, a plate 200b and a plurality of strips 200c. The plate substrate 200b is disposed on the upper portion of the dielectric substrate 200a, and the strips 200c are disposed between the dielectric substrate 200a and the plate 200b, and the dielectric substrate 200a and the edge of the plate 200b are connected. In accordance with the preferred embodiment, the thickness of the dielectric substrate 200a is, for example, between 0.3 mm and 1.1 mm, and the distance between the dielectric substrate 200a and the plate 200b is, for example, between 0.5 mm and 2.0 mm.

Similarly, referring to FIG. 4, the fluorescence substance 202 is disposed on the inner wall of the gas disposed chamber 200, and the fluorescence substance 202 is generally disposed on the dielectric substrate 200a and the surface of the plate 200b. The gas 204 is charged into the gas discharge chamber 200, and an example of the gas is Xe. The electrode 206 is disposed on the outer wall of the gas discharge chamber 200. An example of the electrode is silver electrode.

The flat lamp structure of the present invention is similar to that of the first preferred embodiment, and the only difference is on the design of the spacer 300.

The spacer 300 is designed out of concern for the difficulty of the driving process and the strength of the dielectric substrate 200a; the spacer 300 of the gas discharge chamber 200b can withstand the dielectric substrate 200a and the surface of the plate 200b such that the strength of the dielectric substrate 200a can be enhanced, and its breakage as a result of its inability to withstand the external atmospheric pressure will not occur.

Next, referring to FIG. 5, there is shown the flat lamp structure similar to that shown in FIG. 3, the only difference is on the design of the spacer 300. In accordance with the present preferred embodiment, the dual reinforcement of the spacer 300 with the combination of the carrier 210 deals with the difficulty of the driving process and the strength of the dielectric substrate 200a.

In accordance with the present invention, the dielectric substrate with controllable thickness and uniformity is used to substitute conventional dielectric layer formed from multiple screen printing process and the electrode is disposed on the outer wall of the gas discharge chamber to form external electrodes. Thus, the flat lamp structure of the present invention possesses the following advantages: (1) the replacement of the dielectric layer fabricated by multiple screen printing with the present dielectric substrate provides a simple fabrication process and the fabrication time is shortened, and the yield is improved; (2) the replacement of the dielectric layer fabricated by multiple screen printing with the present dielectric substrate alleviates the error in the fabrication process, thus improving yield and reducing production costs; and (3) excellent thickness uniformity of the dielectric substrate allows for a small difference of electric field between the individual electrodes, thus the uniformity of light emission of the flat lamp is improved.

In order to improve the longevity and efficiency of luminance, the present invention provides another preferred embodiments of the flat fluorescent lamp comprising at least an electrode pair formed by one first electrode and one second electrode, both of which are positioned on different planes.

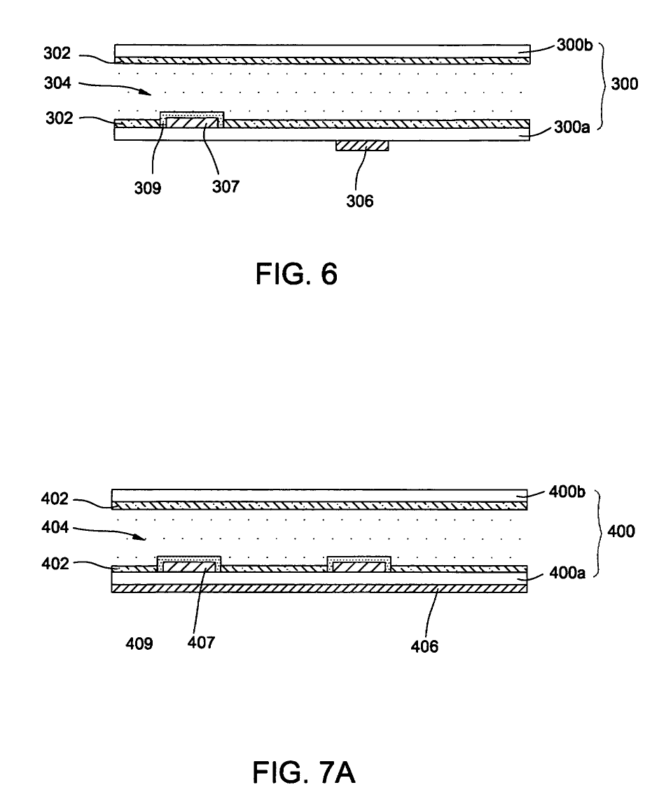

FIG. 6 is the cross-sectional view of the third preferred embodiment of flat fluorescent lamp in accordance with the present invention.

Referring to FIG. 6, the flat fluorescent lamp comprises a dielectric substrate 300a, an upper substrate 300b, a fluorescent substance 302, a discharge gas 304 and a plurality of first and second electrodes 306 and 307. The upper substrate 300a and dielectric substrate 300b are arranged in parallel and therefore a gas discharge chamber 300 is formed therebetween. The gas discharge chamber 300 is filled with the discharge gas 304. The first electrode 306 is disposed on the outer surface of the dielectric substrate 300a without covering the dielectric layer. The second electrode 307 is disposed on the inner surface of the dielectric substrate 300a and is covered with a dielectric layer 309. The fluorescent substance 302 is disposed on the inner surface of the gas discharge chamber 300.

In accordance with the flat fluorescent lamp shown in FIG. 6, the first and second electrodes 306 and 307 can be linear, strip, zigzag, wave or other types.

Assuming the first and second electrodes 306, 307 disposed on the outer and inner surfaces of the dielectric substrate 300a are represented as “A” and “B”, respectively, the arrangement of the electrode pairs shown in FIG. 6 is (ABAB)ₙ. Based on the concept of the present invention, the arrangement of the electrode pairs shown in FIG. 6 can be (ABBA)ₙ, (AAB)ₙ, or (BBA)ₙ.

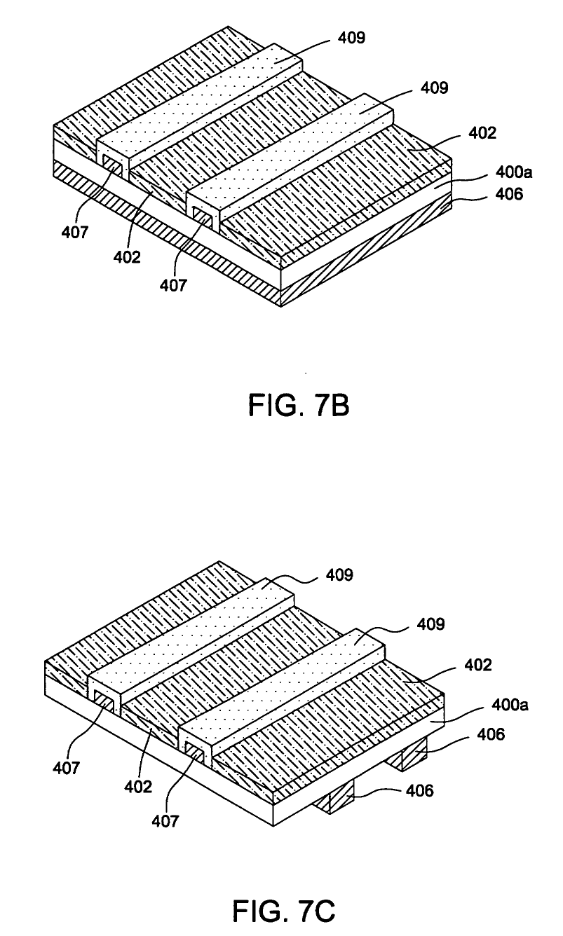

FIG. 7A is a cross-sectional view of a fourth preferred embodiment of the flat fluorescent lamp in accordance with the present invention.

As shown in FIG. 7A, the flat fluorescent lamp comprises a dielectric substrate 400a, an upper substrate 400b, a fluorescent substance 402, a discharge gas 404 and a plurality of first and second electrodes 406, 407. The dielectric substrate 400a and the upper substrate 400b are arranged in parallel and therefore a gas discharge chamber 400 is formed therebetween. The gas discharge chamber 400 is filled with the discharge gas 404. The first electrode 406 is disposed on the outer surface of the dielectric substrate 400a. The second electrode 407 is disposed on the inner surface of the dielectric substrate 400a and is covered with a dielectric layer 409. The fluorescent substance 402 is disposed on the inner surface of the gas discharge chamber 400.

FIGS. 7B and 7C are schematic views of the modifications of the dielectric substrate of the fourth preferred embodiment of the flat fluorescent lamp in accordance with the present invention

In the flat fluorescent lamp shown in FIG. 7B, the first electrode 406 is planar and the second electrode is linear. The second electrode can also be strip, zigzag or other types.

In the flat fluorescent lamp shown in FIG. 7C, the first electrode 406 is linear and the second electrode 407 is linear and perpendicular to the first electrode 406. The first and second electrodes 406, 407 can be strip, zigzag or other type.

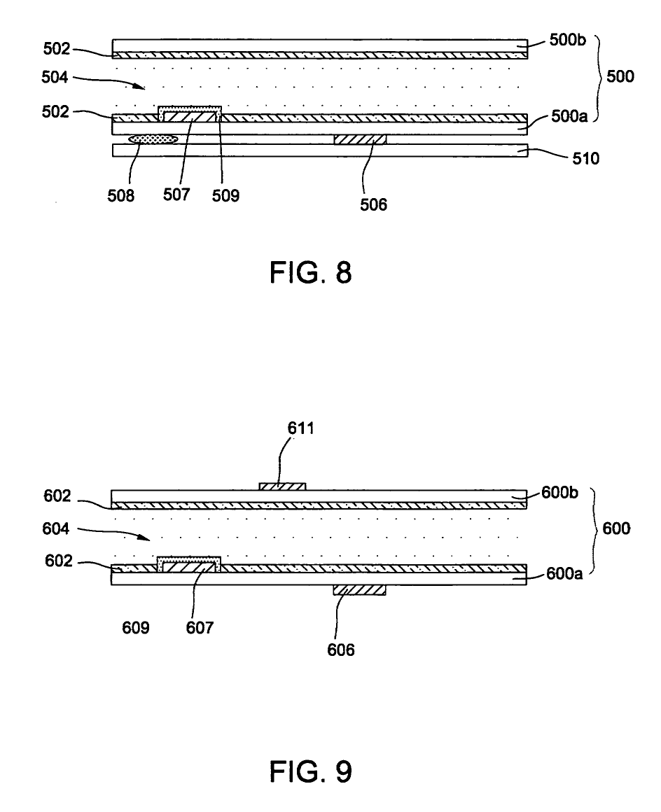

FIG. 8 is the cross-sectional view of a fifth preferred embodiment of flat fluorescent lamp in accordance with the present invention.

The flat fluorescent lamp shown in FIG. 4 comprises a dielectric substrate 500a, an upper substrate 500b, a fluorescent substance 502, a discharge gas 504 and a plurality of first and second electrodes 506, 507. The dielectric substrate 500a and the upper substrate 500b are arranged in parallel and therefore a gas discharge chamber 500 is formed therebetween. The gas discharge chamber 500 is filled with the discharge gas 504. The second electrode 507 is disposed on the inner surface of the dielectric substrate 500a and is covered with a dielectric layer 509.

The flat fluorescent lamp further comprises a carrier substrate 510 disposed beneath the dielectric substrate 500a for supporting the flat fluorescent lamp. The first electrode 506 is disposed on the outer surface of the dielectric substrate 500a or is disposed on one surface of the carrier substrate 510 facing the dielectric substrate 500a. An adhesive 508, such as glass glue, ceramic glue, UV curing adhesive or thermal curing adhesive, is disposed between the dielectric substrate 500a and the carrier substrate 510 for connecting the dielectric substrate 500a and the carrier substrate 510.

Assuming the first and the second electrodes 506 and 507 disposed on the outer and inner surfaces of the dielectric substrate 500a are represented as “A” and “B”, respectively, the arrangement of the electrode pairs shown in FIG. 8 is (ABAB)ₙ. Based on the concept of the present invention, the arrangement of the electrode pairs can be (ABBA)ₙ, (AAB)ₙ, or (BBA)ₙ.

FIG. 9 is the cross-sectional view of a sixth preferred embodiment of flat fluorescent lamp in accordance with the present invention.

Referring to FIG. 9, the flat fluorescent lamp comprises a dielectric substrate 600a, an upper substrate 600b, a fluorescent substance 602, a discharge gas 604 and a plurality of first and second electrodes 606, 607. The dielectric substrate 600a and the upper substrate 600b are arranged in parallel and therefore a gas discharge chamber 600 is formed therebetween. The gas discharge chamber 600 is filled with the discharge gas 604. The first electrode 606 is disposed on the outer surface of the dielectric substrate 600a. The second electrode 607 is disposed on the inner surface of the dielectric substrate 500a and is covered with a dielectric layer 609.

The flat fluorescent lamp shown in the FIG. 9 further comprises a third electrode 611 disposed on the upper substrate 600b. Based on the concept of the present invention, the third electrode 611 can be disposed on the outer surface of the upper substrate 600b. Optionally, the third electrode 611 covered with a dielectric layer like the dielectric layer 609 can be disposed on the inner surface of the upper substrate 600b.

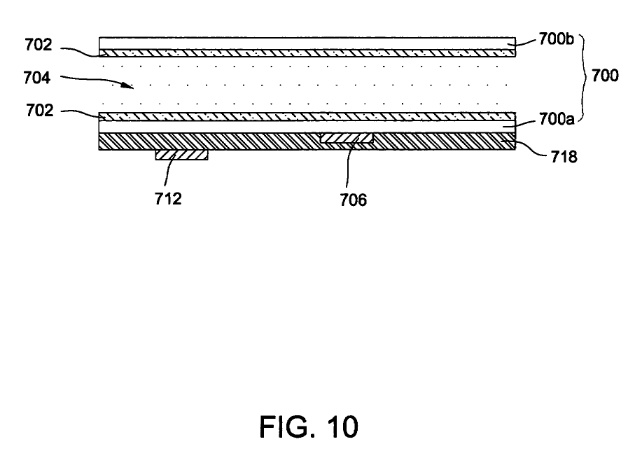

FIG. 10 is the cross-sectional view of a seventh preferred embodiment of flat fluorescent lamp in accordance with the present invention.

As shown in the FIG. 10, the flat fluorescent lamp comprises a dielectric substrate 700a, an upper substrate 700b, a fluorescent substance 702, a discharge gas 704 and a plurality of first and second electrodes 706, 712. The dielectric substrate 700a and the upper substrate 700b are arranged in parallel and therefore a gas discharge chamber 700 is formed therebetween. The gas discharge chamber 700 is filled with the discharge gas 704. The flat fluorescent lamp further comprises a reflective layer 718 beneath the dielectric substrate 700a so that the first electrode 706 is disposed between the dielectric substrate 700a and the reflective layer 718. The second electrode 712 can be disposed on the outer surface of the reflective layer 700a.

In the embodiments of the present invention, the first and second electrodes 706,712 are linear, strip, zigzag or other type. The second electrode 712 is parallel or perpendicular to the first electrode 706. The second electrode 712 can also be planar.

Assuming the electrode pair, i.e. the first and second electrodes 706, 712, is represented as “A” and “B”, respectively, the arrangement of the electrode pairs shown in FIG. 10 is (ABAB)ₙ. Based on the concept of the present invention, the arrangement of the electrode pairs can be (ABBA)ₙ, (AAB)ₙ, or (BBA)ₙ.

In the embodiments shown in FIGS. 6 to 10, the dielectric substrates 300a, 400a, 500a, 600a, 700a are dielectric material such as glass or ceramic and have a thickness of about 0.3-2 mm; the upper substrates 300b, 400b, 500b, 600b, 700b are transparent material such as glass and have a thickness of about 0.3-5 mm; electrodes 306, 307, 406, 407, 506, 507, 606, 607, 611, 706, 712 are conductive material, such as silver, copper, ITO or IZO, having a thickness of 3-50 μm; the fluorescent substance 302, 402, 502, 602, 702 can be excited by the UV light to produce visible light and have a thickness of about 2-400 μm; the discharge gas 304, 404, 504, 604, 704 includes Xe, Ne, Ar, other insert gas, mercury free gas, or a mixture thereof; the dielectric layers 309, 409, 509, 609 are made of PbO, SiO₂, Bi₂O₃, ceramic or combinations thereof and have a thickness of about 30-400 μm; the carrier substrate 510 is glass or ceramic; the adhesive 508 is glass glue, ceramic glue, UV curing adhesive or thermal curing adhesive; and the reflective layer 718 is made of glass material doped with TiO₂, Al₂O₃ or combinations thereof.

As the embodiments illustrated in the present invention, the edges of the upper substrate and the dielectric substrates can be connected with each other or connected by strips to form the gas discharge chambers 300, 400, 500, 600, 700. The distance between the dielectric substrate and the upper substrate is about 0.5-10 mm. At least one spacer can be optionally mounted between the dielectric layer and the upper substrate to maintain the distance.

In accordance with the flat fluorescent lamps in the all embodiments of the present invention, the electrode pair including the first and the second electrodes is disposed on the different planes. In comparison with the conventional flat lamp, the flat fluorescent lamp of this invention can produce a larger discharge area to perform a better efficiency of luminance. Furthermore, in comparison with the conventional flat lamp, the cost of dielectric material could be reduced to a half of conventional design.

While there has been shown and described what are at the present considered the preferred embodiments of the invention, it will be obvious to those skilled in the art that various changes and modifications may be made therein without departing from the scope of the invention as defined by the appended claims.

What is claimed is:

1. A flat fluorescent lamp comprising:
a gas discharge chamber formed between a first substrate and a second substrate and filled with a discharge gas;
a fluorescent substance disposed on an inner surface of the gas discharge chamber; and
at least one electrode pair including a first electrode and a second electrode;
wherein the first and second electrodes are disposed on opposite surfaces of the first substrate, or the first and second electrodes are disposed on the same side of the first substrate but positioned on a different plane.

2. The flat fluorescent lamp as claimed in claim 1, wherein the second electrode is disposed on an inner surface of the first substrate and is covered with a dielectric layer.

3. The flat fluorescent lamp as claimed in claim 2, wherein the dielectric layer is made of PbO, SiO₂, Bi₂O₃, ceramic or combinations thereof and have a thickness at about 30-400 μm.

4. The flat fluorescent lamp as claimed in claim 2, wherein the first or second substrate is linear, strip, zigzag, wave or plane type.

5. The flat fluorescent lamp as claimed in claim 4, wherein the second electrode is arranged in parallel or perpendicular to the first electrode.

6. The flat fluorescent lamp as claimed in claim 5, further comprises a carrier substrate beneath the first substrate.

7. The flat fluorescent lamp as claimed in claim 6, wherein the carrier substrate is glass or ceramic.

8. The flat fluorescent lamp as claimed in claim 6, further comprises an adhesive disposed between the first substrate and the carrier substrate to connect thereof.

9. The flat fluorescent lamp as claimed in claim 8, wherein the adhesive comprises glass glue, ceramic glue, UV curing adhesive or thermal curing adhesive.

10. The flat fluorescent lamp as claimed in claim 2, further comprises a third electrode disposed on the second substrate.

11. The flat fluorescent lamp as claimed in claim 1, further comprises a reflective layer beneath the first substrate so that the first electrode is deposed between the first substrate and the reflective layer.

12. The flat fluorescent lamp as claimed in claim 11, wherein the reflective layer is made of a glass material doped with TiO₂, Al₂O₃ or combinations thereof.

13. The flat fluorescent lamp as claimed in claim 11, wherein the second electrode is disposed on a surface of the reflective layer.

14. The flat fluorescent lamp as claimed in claim 1, wherein the first and second substrates are a dielectric material, glass or ceramic, and have a thickness of about 0.3-5 mm.

15. The flat fluorescent lamp as claimed in claim 1, wherein the first and second electrodes are formed by a conductive material, metal, silver, copper, ITO or IZO and have a thickness of 3-50 μm, respectively.

16. The flat fluorescent lamp as claimed in claim 1, wherein the fluorescent substance is excited by a UV light to produce visible light and has a thickness of about 2-400 μm.

17. The flat fluorescent lamp as claimed in claim 1, wherein the discharge gas comprises Xe, Ne, Ar, insert gas, mercury-free gas, or a mixture thereof.

18. The flat fluorescent lamp as claimed in claim 1, wherein the first and second electrodes are represented as “A” and “B”, respectively, and the arrangement of the first and second electrodes is (ABAB)ₙ, (ABBA)ₙ, (AAB)ₙ or (BBA)ₙ.

19. A flat fluorescent lamp comprising:
a gas discharge chamber comprising
a dielectric layer, and
a substrate disposed on the upper portion of the dielectric substrate;
a fluorescence substance disposed on the inner surface of the gas discharge chamber;
a discharge gas disposed in the gas discharge chamber; and
a plurality of electrodes disposed on the outer surface of the gas discharge chamber;
wherein a distance between the dielectric substrate and the substrate is between 0.5 mm to 10 mm.

20. The flat fluorescent lamp as claimed in claim 19, wherein the gas discharge chamber further comprises:
a plurality of strips disposed between the dielectric substrate and the substrate connected to the edge of the dielectric substrate.

21. The flat fluorescent lamp as claimed in claim 20, wherein the thickness of the dielectric substrate is ranged from 0.3 mm to 2 mm.

22. The flat fluorescent lamp as claimed in claim 19, wherein the discharge gas comprises Xe, Ne, Ar, inert gas, mercury-free gas, or a mixture thereof.

23. The flat fluorescent lamp as claimed in claim 19, wherein the electrode is made of silver, copper, metal, ITO, IZO or a conductive material.

24. The flat fluorescent lamp as claimed in claim 19, further comprising a carrier substrate disposed beneath the dielectric substrate to carry the gas discharge chamber.

25. The flat fluorescent lamp as claimed in claim 24, further comprising an adhesive disposed between the dielectric substrate and the carrier substrate and the adhesive connected the dielectric substrate and the carrier substrate.

26. The flat fluorescent lamp as claimed in claim 25, wherein the adhesive includes a ceramic glue, glass adhesive, UV curing adhesive or thermal curing adhesive.
